(19) United States
(12) Patent Application Publication
(10) Pub. No.: US 2023/0069362 A1
(43) Pub. Date: Mar. 2, 2023

(54) MAINTENANCE SUPPORT SERVER AND MAINTENANCE SYSTEM

(71) Applicant: TOSHIBA TEC KABUSHIKI KAISHA, Tokyo (JP)

(72) Inventors: Takumi FUJITA, Sunto Shizuoka (JP); Hiroyo TANAKA, Koto Tokyo (JP); Tatsuya INAGI, Izu Shizuoka (JP); Satoshi OYAMA, Mishima Shizuoka (JP)

(73) Assignee: TOSHIBA TEC KABUSHIKI KAISHA, Tokyo (JP)

(21) Appl. No.: 17/459,478

(22) Filed: Aug. 27, 2021

(51) Int. Cl. G06Q 10/00

(52) U.S. Cl. CPC G06Q 10/20

(57) ABSTRACT

A maintenance support server includes a communication interface, a first memory, a second memory, and a processor. The communication interface communicates with a terminal device. The first memory stores machine body internal information relating to maintenance to an image forming apparatus. The second memory stores search history information indicating a search history of the machine body internal information with respect to the first memory. The processor stores a search result obtained by searching for the machine body internal information from the first memory in response to a search request from the terminal device as search history information in the second memory and transmits questionnaire information to the terminal device together with the search result.

### FIELD

Exemplary embodiments described herein relate to a maintenance support server and a maintenance system.

### BACKGROUND

In the related art, in a maintenance system, there is a maintenance support tool that enables a serviceman to monitor the internal information of an image forming apparatus to be investigated for failure. Machine body internal information searched in the past using the maintenance support tool can be checked by a usage log of the maintenance support tool. However, there is a problem that failure parts actually specified by a serviceman who searches the machine body internal information, failure contents examined by the serviceman, and the like cannot be confirmed only with the usage log of the maintenance support tool.

### DESCRIPTION OF THE DRAWINGS

FIG. 1 is a diagram illustrating a configuration example of a maintenance system according to at least one embodiment;

FIG. 2 is a block diagram illustrating a configuration example of an MFP of the maintenance system;

FIG. 3 is a block diagram illustrating a configuration example of a server as a maintenance support server in the maintenance system;

FIG. 4 is a diagram illustrating a configuration example of an internal information database that stores a machine body internal information collected from the MFP by a server as the maintenance support server;

FIG. 5 is a diagram illustrating a configuration example of a search history database in which the server as the maintenance support server stores search history information of the machine body internal information;

FIG. 6 is a diagram illustrating a configuration example of a questionnaire generated by the server as the maintenance support server;

FIG. 7 is a diagram illustrating a configuration example of a questionnaire database in which the server as the maintenance support server stores collected questionnaire results;

FIG. 8 is a flowchart illustrating an operation example of the server as the maintenance support server;

FIG. 9 is a display example illustrating a search screen of the machine body internal information displayed on a serviceman terminal by the server as the maintenance support server; and

FIG. 10 is a display example of the search screen of the machine body internal information including the questionnaire displayed on the serviceman terminal by the server as the maintenance support server.

### DETAILED DESCRIPTION

In general, according to at least one embodiment, the maintenance support server includes a communication interface, a first memory, a second memory, and a processor. The communication interface communicates with a terminal device. The first memory stores machine body internal information relating to maintenance to an image forming apparatus. The second memory stores search history information indicating a search history of the machine body internal information with respect to the first memory. The processor stores a search result obtained by searching for the machine body internal information from the first memory in response to a search request from the terminal device as search history information in the second memory and transmits questionnaire information to the terminal device together with the search result.

Hereinafter, at least one embodiment is described with reference to the drawings.

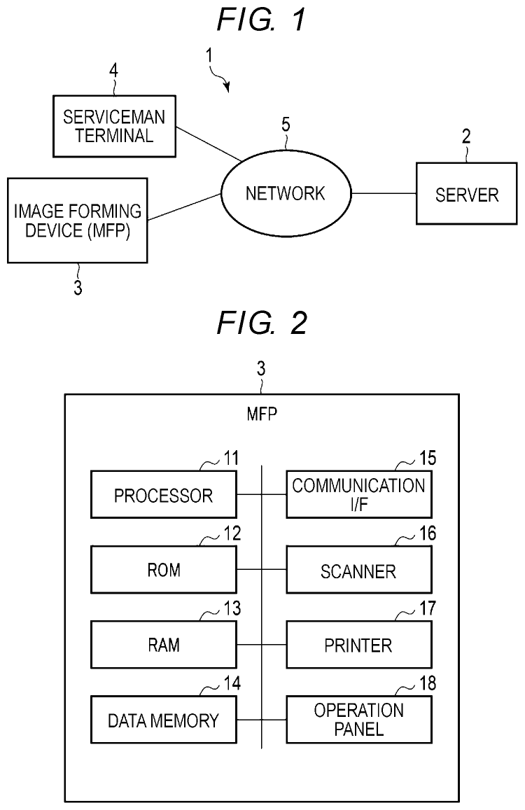

FIG. 1 is a diagram illustrating a configuration example of a maintenance system. 1 according to at least one embodiment.

The maintenance system 1 includes a server 2 as a maintenance support server, a digital multi-functional peripheral (MFP) 3 as an image forming apparatus, and a serviceman terminal 4. The server 2 is connected to the MFP 3 and the serviceman terminal 4 via a network 5 for communication.

The server 2 manages information in order to support maintenance of the MFP 3. The server 2 is connected to the MFP 3 to be maintained for communication. The server 2 collects internal information of a machine body from the MFP 3. The server 2 stores the internal information of the machine body collected from the MFP 3.

The server 2 is connected to the serviceman terminal 4 for communication. The server 2 provides the machine body internal information collected from the MFP 3 in response to a request from the serviceman terminal 4. The server 2 transmits a questionnaire to the serviceman terminal 4 that provides the machine body internal information. The server 2 collects responses for the questionnaire from the serviceman terminal 4. The server 2 aggregates and stores responses for the questionnaire which are collected from the serviceman terminal 4.

The MFP 3 includes a printer, a scanner, an operation panel, and the like. The MFP 3 collects the information indicating a state of the inside of the machine body as the machine body internal information associated with an identifier. The MFP 3 holds the machine body internal information in an internal memory and transmits the information to the server 2 at a predetermined timing.

In at least one embodiment, the MFP 3 is set as a device used by general users. If a problem such as a failure occurs in the MFP 3, the user notifies a predetermined contact such as a service center and requests maintenance work by a serviceman. The serviceman, who receives a request of the maintenance (repair) work from the user, performs maintenance work on the MFP 3.

The serviceman terminal 4 is a terminal device used by the serviceman who performs the maintenance work of the MFP 3. The serviceman terminal 4 is a portable information processing device including a processor, a memory, a display, an operation device, a communication interface, and the like. For example, the serviceman terminal 4 is a portable personal computer (PC), a tablet PC, a smartphone, or the like. The serviceman terminal 4 communicates with the server 2 by the operation of the serviceman.

The serviceman terminal 4 requests the search for the machine body internal information of the identifier designated by the serviceman from the server 2. The serviceman terminal 4 obtains the machine body internal information as the search result provided by the server 2 in response to the search request.

The serviceman terminal 4 may receive a questionnaire for the serviceman together with the search result. If the questionnaire is received from the server 2, the serviceman terminal 4 receives an input of the response to the questionnaire by the serviceman. The serviceman terminal 4 transmits the response to the questionnaire input by the serviceman to the server 2.

Subsequently, the configuration of the MFP 3 as the image forming apparatus is an example of the device to be maintained in the maintenance system 1 according to at least one will be described.

FIG. 2 is a block diagram illustrating a configuration example of the MFP 3 of the maintenance system 1 of at least one embodiment.

As illustrated in FIG. 2, the MFP 3 includes a processor 11, a read only memory (ROM) 12, a random access memory (RAM) 13, a data memory 14, a communication interface (I/F) 15, a scanner 16, a printer 17, an operation panel 18, and the like.

In the configuration example illustrated in FIG. 2, the processor 11, the ROM 12, the RAM 13, the data memory 14, and a communication interface (I/F) 15 configure the system controller. The system controller is connected to the scanner 16, the printer 17, and the operation panel 18. The system controller comprehensively controls the operation of each unit in the MFP 3.

The processor (first processor) 11 executes programs for executing various processes. The processor 11 is, for example, a central processing unit (CPU). The processor 11 is connected to each unit via an internal interface. The processor 11 executes various processes by executing the program stored in the ROM 12 or the data memory 14 by using the RAM 13. For example, the processor 11 collects the information indicating the state of each unit in the MFP 3 by executing the programs, applies identifiers to the collected information, and stores the collected information as the internal information of the machine body.

The RAM 13 functions as a working memory or a buffer memory. The ROM 12 is a non-volatile memory that cannot be rewritten. The ROM 12 stores programs, control data, and the like, set in advance. The data memory 14 is a rewritable non-volatile memory. The data memory 14 stores data such as programs, control data, setting information, and the like. For example, the data memory 14 stores machine body internal information including the information collected from the inside of the machine body.

The communication I/F 15 is an interface (first communication interface) for performing the communication with an external device. For example, the communication I/F 15 is a network interface for communication with the server 2 via a network. The communication I/F 15 may include an interface for local communication with the serviceman terminal 4.

The scanner 16 is a device for optically reading an image of a document. The scanner 16 reads an image of a document set on a platen glass. The scanner 16 may include an auto document feeder (ADF). The scanner 16 including the ADF reads an image of a document conveyed by the ADF.

The printer 17 forms an image on a medium such as paper. For example, the printer 17 forms an image on the paper extracted from a paper cassette for storing the paper. The printer 17 may include an image forming mechanism of any image forming method. For example, if an electrophotographic image forming mechanism is included, the printer 17 forms a developer image on an image carrier such as a photoconductor drum and transfers the developer image on the image carrier to paper. If an inkjet type image forming mechanism is included, the printer 17 forms an image on paper by ink ejected by inkjet heads.

The operation panel 18 is a user interface. The operation panel 18 includes a display, a touch panel, and a plurality of operation buttons. The display of the operation panel 18 displays an operation guide and the like. The touch panel of the operation panel 18 is provided on the display screen of the display. The touch panel detects a part touched by the user on the display screen of the display. The operation buttons are buttons for inputting specific operation instructions.

Subsequently, the configuration of the server 2 as the maintenance support server in the maintenance system 1 according to at least one embodiment is described.

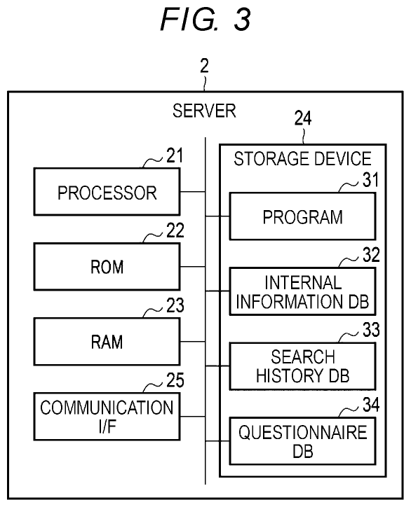

FIG. 3 is a block diagram illustrating a configuration example of the server 2 as a maintenance support server in the maintenance system 1 according to at least one embodiment.

As illustrated in FIG. 3, the server 2 includes a processor 21, a read only memory (ROM) 22, a random access memory (RAM) 23, a storage device 24, a communication interface (I/F) 25, and the like.

The processor (second processor) 21 executes a program for executing various processes. The processor 21 is, for example, a CPU. The processor 21 is connected to each unit via an internal interface. The processor 21 executes various processes by executing the programs stored in the ROM 22 or the storage device 24 by using the RAM 23.

The RAM 23 functions as a working memory or a buffer memory. The ROM 22 is a non-volatile memory that cannot be rewritten. The ROM 22 stores programs, control data, and the like, set in advance.

The storage device 24 is a rewritable non-volatile memory. The storage device 24 stores data such as programs, control data, setting information, and the like.

In the configuration example illustrated in FIG. 3, the storage device 24 includes storage areas 31 to 34. The storage area 31 is a memory that stores a program. The storage area 31 stores various programs that support the MFP 3 for the maintenance. The storage area 32 is a first memory that stores an internal information database (DB). The internal information database is a database that stores the internal information collected from the MFP 3 to be maintained. The storage area 33 is a second memory that stores a search history database (DB). The search history database is a database that stores the information indicating the search history for the internal information. The storage area 34 is a third memory that stores a questionnaire database (DB). The questionnaire database is a database that stores the response for the questionnaire.

The communication I/F 25 is an interface (second communication interface) for performing the communication with an external device. For example, the communication I/F 25 is a network interface for communication with the MFP 3 and the serviceman terminal 4 via a network.

Subsequently, the entire operation of the maintenance system. 1 according to at least one embodiment is schematically described.

The MFP 3 stores the machine body internal information obtained by applying the identifier to the information relating to the operation state of each unit inside the machine body (internal information) in the data memory 14. For example, the processor 11 of the MFP 3 stores the number of sheets on which the printer 17 prints a monochrome image or a color image on paper (counter value) as the machine body internal information in the data memory 14. The processor 11 of the MFP 3 stores information obtained by applying an identifier to information such as setting information as the machine body internal information. The processor 11 of the MFP 3 stores information obtained by applying the identifier to the number of times of scanning the document by the scanner 16 as the machine body internal information. The processor 11 of the MFP 3 stores information obtained by applying the identifier respectively to information relating to rotation of a motor in each unit, information relating to driving of a driving mechanism, and the like as the machine body internal information.

The processor 11 of the MFP 3 uploads the machine body internal information stored in the data memory 14 at a predetermined timing (for example, periodically) to the server 2 by the communication interface 25.

The server 2 obtains the machine body internal information uploaded from the MFP 3 by the communication interface 25. The processor 21 of the server 2 stores the machine body internal information obtained from the MFP 3 in the internal information database of the storage area 32.

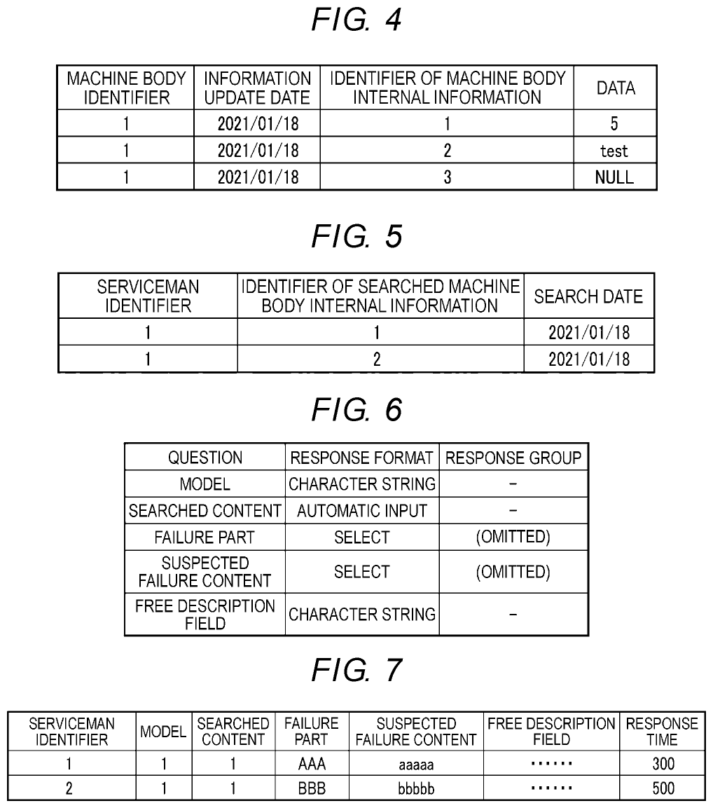

FIG. 4 is a diagram illustrating a configuration example of the internal information database that stores the machine body internal information collected from the MFP 3 by the server 2.

In the example illustrated in FIG. 4, the machine body identifier, information update date, the identifier of the internal information, data, and the like are stored in the internal information database. The machine body identifier is information indicating the MFP 3 which is a source of the machine body internal information. The information update date indicates a date when the machine body internal information is stored. The identifier of the internal information is an identifier for identifying the content of the machine body internal information. The data indicates data of the machine body internal information. According to the internal information database illustrated in FIG. 4, the machine body internal information can be searched by the identifier.

The server 2 starts a program that provides a maintenance support service and receives an access from the serviceman terminal 4 that can communicate with the communication interface 25. For example, the serviceman terminal 4 requests the logging-in of the serviceman specified by the identifier of the serviceman from the server 2. If the authentication of the serviceman by the predetermined authentication process is successful, the processor 21 of the server 2 sets the corresponding serviceman to be in the logged-in state and provides the maintenance support service.

The processor 21 of the server 2 searches for the internal information database in response to the request from the logged-in serviceman. For example, if the serviceman designates an identifier of the machine body internal information and requests a search, the processor 21 extracts the machine body internal information of the designated identifier from the internal information database. The processor 21 displays the machine body internal information (search result) extracted from the internal information database on a display unit of the serviceman terminal 4.

The processor 21 of the server 2 stores the information that indicates the search history performed in response to the search request from the serviceman terminal 4 in the search history database. The search history database stores the search history information indicating which serviceman searches for what kind of machine body internal information and when.

FIG. 5 is a diagram illustrating a configuration example of the search history database that stores search history indicating the machine body internal information searched by the server 2.

In the example illustrated in FIG. 5, the serviceman identifier, the identifier of the searched machine body internal information, the search date, and the like are stored in the search history database. The serviceman identifier is an identifier indicating the serviceman who performs the search. The identifier of the searched machine body internal information is an identifier of the machine body internal information to be searched. The search date is a date when the corresponding machine body internal information is searched.

According to the search history database indicated in FIG. 5, the search history can be searched by the identifier of the machine body internal information, and the number of times of the search for specific machine body internal information can be specified. According to the search history database illustrated in FIG. 5, the serviceman who performs the search can be specified, and thus the searched content searched by each serviceman can be checked.

Together with the search result obtained by searching the internal information database in response to the request from the serviceman, the server 2 may transmit a questionnaire to the serviceman. For example, if the number of times of the search for the identifier of the internal information designated as a search target by the serviceman exceeds a predetermined threshold value, the processor 21 of the server 2 sends the questionnaire together with the search result.

As the questionnaire, for example, response items such as the purpose of the search, a part to be maintained, a phenomenon therein, or investigation contents are prepared. The questionnaire is configured so that the serviceman can respond by free description or in a selection format by using the serviceman terminal 4 or the like. If a response to the questionnaire is obtained, the server 2 stores the obtained response in the questionnaire database.

FIG. 6 is a diagram illustrating a configuration example of the questionnaire generated by the server 2. FIG. 7 is a diagram illustrating a configuration example of the questionnaire database that stores responses (questionnaire results) to the questionnaire which are collected by the server 2.

In the example illustrated in FIG. 6, examples of the questionnaire for which the server 2 asks a response include a model, searched contents, a failure part, suspected failure contents, and a free description field.

The model is information indicating a model of the MFP 3 to be maintained. The searched content is an identifier of the machine body internal information searched by the serviceman. The failure part is information indicating apart to be a target of the failure (maintenance) in the MFP 3. The suspected failure contents are information indicating failure contents suspected by the serviceman who obtains a search result for the machine body internal information. The free description field is for a comment to be described in a free format by the serviceman with respect to the questionnaire result.

For example, for the model and the free description field, responses are received by character strings. The searched contents are identifiers of the machine body internal information designated (input) by the serviceman as the search target and thus automatically set to the response. The failure part and the suspected failure content are selected by the serviceman from options promoted by the server 2.

In the example illustrated in FIG. 7, the questionnaire database stores the serviceman identifier, the model, the searched content, the failure part, the suspected failure content, the free description field, and the response time. The serviceman identifier is an identifier indicating the serviceman who performs the search. The model is information indicating a model of the MFP 3 to be maintained which is input by the serviceman as a response. The searched content is an identifier of the machine body internal information for which the serviceman requests the search. The failure part and the suspected failure content are responses selected by the serviceman from the options promoted by the server 2. The free description field is contents responded to by the serviceman in a free format in the questionnaire result. The response time is time required to obtain the corresponding questionnaire result from when the questionnaire is transmitted.

According to the questionnaire database illustrated in FIG. 7, the failure part, the failure content suspected by the serviceman, and the like can be checked for each kind of machine body internal information searched by the serviceman. According to the questionnaire database, the questionnaire result can be aggregated for each searched content (searched machine body internal information). According to the questionnaire database, what kind of failure tends to be suspected can be checked for each kind of the searched machine body internal information.

The processor 21 of the server 2 generates a report based on the response (questionnaire result) stored in the questionnaire database. For example, the processor 21 generates a report showing the purpose of use of the search result for the machine body internal information for which the number of times of the search is large or the report showing the maintenance contents performed by using the search results, from the questionnaire results. The processor 21 may generate a report including information showing frequent cases, rare cases, or search contents that are likely to be continuously searched in the MFP. The processor 21 may generate a report obtained by aggregating the search frequency of the machine body internal information for each part in the MFP.

Subsequently, the operation of the maintenance support of the MFP 3 by the server 2 as the maintenance support server according to the embodiment is described.

In the maintenance system 1, as described above, the MFP 3 applies identifiers to the internal information obtained from the inside of the machine bodies and collects and stores the identifiers in the data memory 14 as the machine body internal information. The MFP 3 uploads the machine body internal information collected and stored in the data memory 14 to the server 2 at a predetermined timing. The server 2 stores the machine body internal information uploaded from the MFP 3 in the internal information database.

The processor 21 of the server 2 receives an access from the communicable serviceman terminal 4 via the communication interface 25 at any timing. The processor 21 starts a program for the maintenance support and receives a log-in of the serviceman who uses the serviceman terminal 4. If the logging-in of the serviceman who operates the serviceman terminal 4 is permitted, the processor 21 receives the search request of the machine body internal information from the corresponding serviceman terminal 4.

For example, the processor 21 displays the search screen for searching the machine body internal information on the display unit of the serviceman terminal 4. With the serviceman terminal 4, the serviceman inputs the identifier of the machine body internal information and instructs the search request for the machine body internal information. The serviceman terminal 4 sends the search request of the machine body internal information of the identifier input by the serviceman to the server 2.

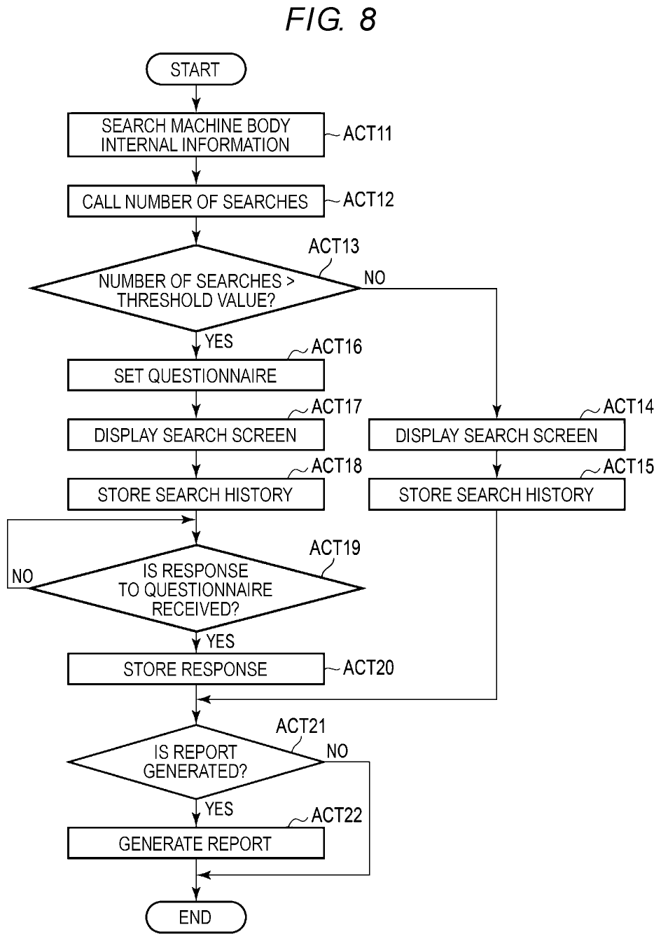

FIG. 8 is a flowchart illustrating an operation example of the maintenance support of the MFP 3 in the server 2 according to the embodiment.

The processor 21 of the server 2 searches for the machine body internal information of the identifier designated in response to the search request from the serviceman terminal 4 (ACT 11). For example, the processor 21 extracts the machine body internal information of the identifier designated by the serviceman terminal 4 from the internal information database.

The processor 21 calculates the number of times of the search for the machine body internal information of the identifier designated as a search target with the serviceman terminal 4 (ACT 12). The processor 21 calculates the number of times of the search for the machine body internal information of the identifier designated based on the search history database. For example, the processor 21 calculates the number of times of the search by counting the number of cases of the search history information including the designated identifier as the search history database.

If the number of times of the search for the designated machine body internal information is calculated, the processor 21 determines whether the number of times of the search exceeds the predetermined threshold value (ACT 13). The predetermined threshold value is a value for determining whether the questionnaire relating to the searched content is given with respect to a service for which the search is requested. For example, the predetermined threshold value is set in advance and stored in the storage device 24.

If the number of times of the search does not exceed the predetermined threshold value (No in ACT 13), the processor 21 displays the search screen including the search result on the display unit of the serviceman terminal 4 (ACT 14). The processor 21 stores the search result in the search history database as the search history information (ACT 15).

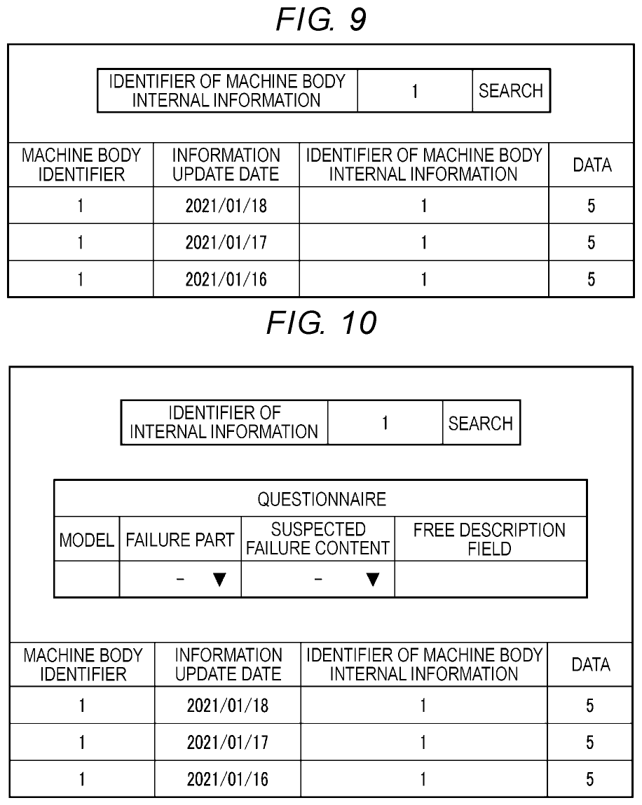

FIG. 9 is a diagram illustrating a display example of the search screen of the machine body internal information that is displayed on the display unit of the serviceman terminal 4 by the server 2.

In the display example illustrated in FIG. 9, the search screen displayed on the display unit of the serviceman terminal 4 is provided with an input field for inputting an identifier of the internal information and a search button for instructing the search. On the search screen illustrated in FIG. 9, together with the input field and the search button, the search result of the machine body internal information by the identifier input to the input field is displayed.

The serviceman who operates the serviceman terminal 4 inputs the identifier of the machine body internal information desired to be searched to the input field on the search screen illustrated in FIG. 9 to perform instruction with the search button. If the instruction is made with the search button in a state in which the identifier is input, the serviceman terminal 4 requests the search of the machine body internal information of the identifier input to the input field from the server 2.

If the search button is instructed at the serviceman terminal 4, the processor 21 of the server 2 searches the internal information database for the machine body internal information of the identifier input to the input field. The server 2 displays the search result to be displayed on the search screen on the display unit of the serviceman terminal 4. In the display example of the search screen illustrated in FIG. 9, together with the input field and the search button, the search result of the machine body internal information of the identifier input to the input field is displayed. For example, as the search result displayed on the search screen, the machine body internal information of the identifier input to the input field is displayed in a list in the order of the information update date.

If the number of times of the search exceeds the predetermined threshold value (Yes in ACT 13), the processor 21 sets the questionnaire for requesting the response from the serviceman (transmits the questionnaire information) together with the search result (ACT 16). For example, the processor 21 sets the questionnaire on the search screen displayed on the display unit of the serviceman terminal 4. Accordingly, the server 2 transmits the questionnaire information to the serviceman terminal together with the search result. As illustrated in FIG. 6 above, the content of the questionnaire requests the response to the model, the searched contents, the failure part, the suspected failure contents, the free description field, and the like.

If the questionnaire requested to the serviceman is set, the processor 21 displays the search screen including the search result and the questionnaire on the display unit of the serviceman terminal 4 (ACT 17). The processor 21 stores the search result in the search history database as the search history information (ACT 18).

FIG. 10 is a diagram illustrating a display example of the search screen of the machine body internal information including the questionnaire displayed on the display unit of the serviceman terminal 4 by the server 2.

In the display example illustrated in FIG. 10, questionnaire (questionnaire screen) is set on the search screen illustrated in FIG. 9. The questionnaire screen displayed on the search screen illustrated in FIG. 10 displays the response fields for the model, the failure part, the suspected failure contents, the free description field, and the like.

For example, the serviceman inputs the character strings indicating the model of the MFP 3 to be maintained in the field of the model in the serviceman terminal 4. The serviceman selects and inputs the part to be the target of the failure (maintenance) from the options displayed in the field of the failure part in the serviceman terminal 4. If the machine body internal information is searched from the options displayed in the field of the suspected failure content in the serviceman terminal 4, the serviceman selects and inputs the suspected failure content. The serviceman inputs comments in a free format to the free description field in the serviceman terminal 4 with character strings.

The processor 21 receives the response to the corresponding questionnaire in the state in which the search screen including the questionnaire is displayed on the display unit of the serviceman terminal 4 (ACT 19). The processor 21 receives the response to questionnaire at any timing. Here, the questionnaire screen is enabled to be displayed again after being once closed by the serviceman terminal 4. Accordingly, the serviceman may not immediately respond to the questionnaire on the search screen and may be respond to the questionnaire at any timing. However, in order to track the time until the response to the questionnaire is received, the processor 21 stores the time if the questionnaire is transmitted in the RAM 23 or the storage device 24.

If the response to the questionnaire is obtained, the processor 21 stores the response content to the questionnaire in the questionnaire database (ACT 20). For example, the processor 21 records the serviceman identifier, the model, the searched contents, the failure part, the suspected failure contents, the free description field, the response time, and the like in the questionnaire database. Here, the processor 21 specifies the time required to obtain the response (response time) from the time when the questionnaire is transmitted and the time when the response to the corresponding questionnaire is received.

The processor 21 of the server 2 determines whether it is required to generate the report based on the response stored in the questionnaire database (ACT 21). For example, the processor 21 may generate a report at a predetermined timing. The processor 21 may generate a report in response to the request from the serviceman. The processor 21 may generate a report on the machine body internal information that the number of times of the search exceeds the predetermined time (for example, the value larger than the above predetermined threshold value).

If it is determined that the report is to be generated (Yes in ACT 21), the processor 21 generates the report based on the questionnaire database (ACT 22). For example, the processor 21 generates the report including the distribution of the failure part for each kind of the machine body internal information. The processor may generate a report including the distribution of the suspected failure contents for each kind of the machine body internal information. The processor 21 may generate a report including a list of the suspected failure contents for each serviceman and may generate a report including the distribution of the failure part or the failure contents for each model.

The processor 21 of the server 2 stores the generated report in the storage device 24. The processor 21 may transmit the generated report to an external device set in advance. The processor 21 may display the generated report on the display unit of the serviceman terminal 4.

As described above, the server as the maintenance support server according to at least one embodiment collects the machine body internal information from the MFP and stores the machine body internal information in the internal information database. The server searches the machine body internal information of the identifier designated in response to the search request from the serviceman terminal and provides the search result to the serviceman terminal. If the number of times of the search for the machine body internal information of the designated identifier exceeds the predetermined threshold value, the server supplies the questionnaire relating to the maintenance to the serviceman terminal together with the search result. The server stores the response to the questionnaire in the questionnaire database.

Accordingly, with the server according to at least one embodiment, the content of the maintenance performed by the serviceman who searches the machine body internal information of the specific identifier can be checked afterwards. As a result, the information relating to the maintenance which cannot be checked only with the search history of the machine body internal information can be intensively checked, and thus the work efficiency of the maintenance work can be improved.

While certain embodiments have been described, these embodiments have been presented by way of example only, and are not intended to limit the scope of the disclosure. Indeed, the novel apparatus and methods described herein may be embodied in a variety of other forms; furthermore, various omissions, substitutions and changes in the form of the apparatus and methods described herein may be made without departing from the spirit of the disclosure. The accompanying claims and their equivalents are intended to cover such forms or modifications as would fall within the scope and spirit of the disclosure.

What is claimed is:

1. A maintenance support server comprising:
a communication interface configured to communicate with a terminal device;
a first memory configured to store machine body information relating to maintenance to an image forming apparatus;
a second memory configured to store search history information indicating a search history of the machine body information with respect to the first memory; and
a processor configured to:
store a search result obtained by searching for the machine body information from the first memory in response to a search request from the terminal device as search history information in the second memory; and
transmit questionnaire information to the terminal device together with the search result.

2. The server according to claim 1, wherein
the processor is configured to transmit the questionnaire information to the terminal device together with the search result when a number of times of searching for the machine body internal information for which search is requested by the search request exceeds a predetermined threshold value.

3. The server according to claim 1, wherein
the questionnaire information includes a content based on a purpose for the search.

4. The server according to claim 1, wherein
the questionnaire information includes a content based on a part to be maintained when the search is performed.

5. The server according to claim 1, wherein
the questionnaire information includes a content based on a model of the image forming apparatus to be maintained when the search is performed.

6. The server according to claim 1, further comprising:
a third memory configured to store a response to a questionnaire indicated by the questionnaire information, wherein
the processor is configured to store information indicating the obtained response in the third memory when the response to the questionnaire information is obtained.

7. The server according to claim 6, wherein
the processor is configured to store information indicating a time from the transmission of the questionnaire information to the obtaining of the response in the third memory, when the response to the questionnaire information is obtained.

8. The server according to claim 6, wherein
the processor is configured to generate a report based on the response to the questionnaire stored in the third memory.

9. The server according to claim 1, wherein the machine body internal information includes at least one of identification information or setting information of the image forming apparatus.

10. The server according to claim 1, wherein the questionnaire information includes serviceman identification.

11. A maintenance system comprising:
an image forming apparatus; and
a maintenance support server, wherein
the image forming apparatus includes:
a first communication interface configured to communicate with the maintenance support server,
a first processor configured to transmit machine body internal information relating to maintenance to the image forming apparatus to the maintenance support server by the first communication interface, and
the maintenance support server includes:
a second communication interface configured to communicate with a terminal device,
a first memory configured to store the machine body internal information,
a second memory configured to store search history information indicating a search history for the machine body internal information from the first memory, and
a second processor configured to:
store a search result obtained by searching the machine body internal information from the first memory in response to a search request from the terminal device in the second memory as search history information; and
transmit questionnaire information to the terminal device together with the search result.

12. The system according to claim 9, wherein
the second processor of the maintenance support server is configured to transmit questionnaire information to the terminal device together with the search result, when a number of times of the search for the machine body internal information for which search is requested by the search request exceeds a predetermined threshold value.

13. The system according to claim 11, wherein the questionnaire information includes serviceman identification.

14. The system according to claim 11, wherein
the questionnaire information includes a content obtained based on a purpose for the search.

15. The system according to claim 11, wherein
the questionnaire information includes a content obtained based on a part to be maintained when the search is performed.

16. The system according to claim 11, wherein
the questionnaire information includes a content obtained based on a model of the image forming apparatus to be maintained when the search is performed.
